(19) United States
(12) Patent Application Publication
(10) Pub. No.: US 2026/0269519 A1
(43) Pub. Date: Sep. 10, 2026

(54) ELECTRICAL CONNECTION SYSTEM INCLUDING SHIELD AND MATING COMPONENT AND METHOD FOR CONNECTING SHIELD AND MATING COMPONENT

(71) Applicant: Yazaki North America, Inc., Canton, MI (US)

(72) Inventors: Robert Steven Massar, Canton, MI (US); Justin Thomas Gerwatowski, Canton, MI (US)

(21) Appl. No.: 19/073,337

(22) Filed: Mar. 7, 2025

(51) Int. Cl. H01R 13/58; H01R 13/6581; H01R 13/6593; B60R 16/02

(52) U.S. Cl. CPC H01R 13/5816; H01R 13/6581; H01R 13/6593; B60R 16/0207; H01R 2201/26

(57) ABSTRACT

An electrical connection kit for a wire harness cable can include a shield shell that covers an electrical terminal, and first and second strain relief components. The first and second strain relief components can include a plurality of fist ribs and second ribs, respectively, extending from their inner surfaces. An innermost surface of each of the first ribs can be located on an imaginary circle having a diameter of a first value, while an innermost surface of each of the second ribs can be located on an imaginary circle having a diameter of a second value different from the first value, such that the first and second strain relief components are configured for use with wire harness cables that have different diameters.

### BACKGROUND

The disclosed subject matter relates to shields and methods for securing and protecting an electrical terminal. In particular, the disclosed subject matter relates to shielded connectors for high voltage wire harnesses in a vehicle, the shield including features that allow the shield to connect to various types of wires.

In a vehicle, an electromagnetic compatibility (EMC) shield is commonly used to prevent electromagnetic interference (EMI) or radio frequency interference (RFI) from, for example, the high voltage wiring harness and its connections from impacting sensitive electronics in the vehicle. This can be achieved by using a metallic screen or cover to absorb the electromagnetic fields that are generated by current flowing through the wire harness. The screen or cover absorbs the electromagnetic fields, and causes a current within the body of the screen or cover. This current can be absorbed by a ground connection.

By absorbing these electromagnetic fields before they reach sensitive circuitry, the protected signal is kept clean of electromagnetic interference, maximizing shielding effectiveness.

Several techniques and materials can be used for EMC shielding, and the materials used depend on the type of electronics and frequencies involved. The amount of EMI reduction/blocking depends on the material used, the size of the shielded volume, the material thickness as well as other factors. Each of these factors affects the range and strength of frequencies that can be absorbed by the shielding.

Some examples of EMC shielding material include metals, metallic foils or plaited braid to shield equipment wires and connections. The connectors on the ends of the wire can be protected using metal covers, and the braiding or foil from the wires can be attached to the metal cover to enhance EMC shielding.

Conductive paints and magnetic materials can also be used for EMC shielding in certain environments. Other EMC shielding materials can include sheet metal, metal foam, conductive plastics, and mesh-metal screening.

Depending on the frequency, the shielding does not have to be a solid screen, but can have regularly placed holes, or wire fencing. It is helpful to understand exactly which part of the electromagnetic frequency spectrum needs to be guarded against in any particular application.

Ultimately, shielding is beneficial where any sensitive electronic element requires isolation from the surrounding electromagnetic fields, or where a particular element is transmitting unwanted additional signals.

There are many problems and issues in the shielded connector technology that have been addressed and are yet unresolved to date. For example, many shielded connectors require separate shield covers for different sized wires. In addition, some shielded connectors include multiple fasteners to ensure proper force distribution about a perimeter of the shield when connected to a target structure or device. The additional shield covers and/or connectors add to part cost and increase the manufacturing time and repair time for the connectors.

Strain relief components associated with shield covers have typically been part of a wire lead assembly that extends into the shield cover when assembled. Therefore, assembly order and orientation are predetermined and part of the manufacturing process. Strain relief components typically remain on the wire harness through multiple manufacturing processes such as welding, cramping, etc., and must be correctly oriented and positioned at assembly of a wire lead to a connector. Thus, there is a longstanding need for more simplified and streamlined manufacture of shield shells with strain relief components.

Strain relief features that are cast into external shield shells reduces wire lead assembly complexity but require unique castings to accommodate more than one wire size. Thus, again, a need for more adaptability of the strain relief feature for different sized wires has been present and unmet for shielded connectors.

### SUMMARY

In accordance with an aspect of the disclosed subject matter, an electrical connection kit for a wire harness cable and electrical terminal, can include: a shield shell configured to cover at least a portion of the electrical terminal and having a shell collar configured to at least partially surround the wire harness cable when the wire harness cable extends along a cable axis into the shield shell; a first strain relief component having an inner surface configured to face the cable axis and an outer surface configured to mate with the shell collar, the first strain relief component including a plurality of first ribs extending from the inner surface towards the cable axis when the first strain relief component is located in the shell collar, and each of the first ribs extending in a longitudinal direction that is parallel with the cable axis, wherein an innermost surface closest to the cable axis of each of the first ribs is located on an imaginary circle having a diameter of a first value when the first strain relief component is located in the shell collar; and a second strain relief component having an inner surface configured to face the cable axis and an outer surface configured to mate with the shell collar, the second strain relief component including a plurality of second ribs extending from the inner surface of the second strain relief component towards the cable axis when the second strain relief component is located in the shell collar, and each of the second ribs extending in a longitudinal direction that is parallel with the cable axis, wherein an innermost surface closest to the cable axis of each of the second ribs is located on an imaginary circle having a diameter of a second value when the second strain relief component is located in the shell collar, and the first value is different from the second value, such that the first strain relief component is configured for use with a wire harness cable having a first diameter, and the second strain relief component is configured for use with a wire harness cable having a second diameter different than the first diameter.

In accordance with another aspect of the disclosed subject matter, an electrical connection kit for a cable and electrical terminal can include: a shield shell including an upper shield shell, a lower shield shell, and connector structure configured to connect the upper shield shell to the lower shield shell, the upper shield shell and lower shield shell forming at least one tubular channel configured to receive the cable when the upper shield shell is connected to the lower shield shell, and the tubular channel having a cable axis along which the cable extends into the shield shell when the cable is mounted in the tubular channel of the shield shell, the shield shell made from an electromagnetic compatibility material; a first strain relief component having an inner surface configured to face the cable axis and an outer surface configured to mount to an inner circumferential surface of the tubular channel of the shield shell, the first strain relief component including a plurality of first ribs extending from the inner surface towards the cable axis when the first strain relief component is mounted to the tubular channel of the shield shell, wherein an innermost surface closest to the cable axis of each of the first ribs is located on an imaginary circle having a diameter of a first value when the first strain relief component is mounted to the tubular channel of the shield shell, the first strain relief component made from a material having higher elasticity than the electromagnetic compatibility material; and a second strain relief component having an inner surface configured to face the cable axis and an outer surface configured to mount to the inner circumferential surface of the tubular channel of the shield shell, the second strain relief component including a plurality of second ribs extending from the inner surface of the second strain relief component towards the cable axis when the second strain relief component is mounted to the tubular channel of the shield shell, wherein an innermost surface closest to the cable axis of each of the second ribs is located on an imaginary circle having a diameter of a second value when the second strain relief component is mounted to the tubular channel of the shield shell, and the first value is different from the second value, such that the first strain relief component is configured for use with a cable having a first diameter, and the second strain relief component is configured for use with a cable having a second diameter different than the first diameter, the second strain relief component made from a material having higher elasticity than the electromagnetic compatibility material.

In accordance with another aspect of the disclosed subject matter, a method for connecting a shield shell to a cable and electrical terminal can include: providing a shield shell including an upper shield shell, a lower shield shell, and a connector structure configured to connect the upper shield shell to the lower shield shell, the shield shell made from an electromagnetic compatibility material; providing a first strain relief component having an inner surface including a plurality of first ribs extending from the inner surface a first distance, the first strain relief component made from a material having higher elasticity than the electromagnetic compatibility material; providing a second strain relief component having an inner surface including a plurality of second ribs extending from the inner surface a second distance different from the first distance, the second strain relief component made from a material having higher elasticity than the electromagnetic compatibility material; selecting a cable having an outer diameter; selecting one of the first strain relief component and second strain relief component depending on a value of the outer diameter of the cable; mounting the selected one of the first strain relief component and second strain relief component to the shield shell; placing the electrical terminal and cable adjacent at least one of the upper shield shell and lower shield shell; and, connecting the upper shield to the lower shield shell after the selected one of the first strain relief component and second strain relief component is mounted to the shield shell such that an innermost surface of the plurality of ribs is coincident with the outer diameter of the cable and the cable is firmly held by the selected one of the first strain relief component and second strain relief component.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1A is a perspective exploded view of a connector made in accordance with principles of the disclosed subject matter.

FIG. 1B is an end view of the connector of FIG. 1A.

FIG. 2A is an exploded perspective view of the upper shield shell and an upper strain relief component of the connector of FIG. 1A.

FIG. 2B is a perspective view of the upper shield shell of the connector of FIG. 1A in an assembled state with respect to the upper strain relief component.

FIG. 2C is an exploded perspective view of the lower shield shell and a lower strain relief component of the connector of FIG. 1A.

FIG. 2D is a perspective view of the lower shield shell of the connector of FIG. 1A in an assembled state with respect to the lower strain relief component.

FIG. 3A is an end view of the connector of FIG. 1A with a first strain relief component.

FIG. 3B is an end view of the connector of FIG. 1A with a second strain relief component.

FIG. 3C is an end view of the connector of FIG. 1A with a third strain relief component.

FIG. 4A is a perspective view of a strain relief component in a correct assembly orientation with respect to the upper shield of the connector of FIG. 1A.

FIG. 4B is an end view of the strain relief component of FIG. 4A in a correct assembly orientation with respect to the upper shield of the connector of FIG. 1A.

FIG. 4C is a perspective view of a strain relief component in an incorrect assembly orientation with respect to the upper shield of the connector of FIG. 1A.

FIG. 4D is a bottom perspective view of the strain relief component of FIG. 4C in an incorrect assembly orientation with respect to the upper shield of the connector of FIG. 1A.

FIG. 5 is a partial perspective view of the upper shield of the connector of FIG. 1A.

FIG. 6A is a cross a cross-section take along line VI-VI of FIG. 5 with the strain relief component in a pre-assembled position.

FIG. 6B is a cross a cross-section take along line VI-VI of FIG. 5 with the strain relief component in a partial-assembled position.

FIG. 6C is a cross a cross-section take along line VI-VI of FIG. 5 with the strain relief component in an assembled position.

FIG. 7 is a partial perspective view of another embodiment of an upper shield shell and strain relief component made in accordance with principles of the disclosed subject matter.

FIG. 8A is a cross a cross-section take along line VIII-VIII of FIG. 7 with the strain relief component in a pre-assembled position.

FIG. 8B is a cross a cross-section take along line VIII-VIII of FIG. 7 with the strain relief component in an assembled position.

FIG. 9 is a partial perspective view of another embodiment of an upper shield shell made in accordance with principles of the disclosed subject matter.

FIG. 10A is a cross a cross-section take along line X-X of FIG. 9 with the strain relief component in a pre-assembled position.

FIG. 10B is a cross a cross-section take along line X-X of FIG. 9 with the strain relief component in an initial assembled state.

FIG. 10C is a cross a cross-section take along line X-X of FIG. 9 with the strain relief component in a final assembled state.

FIG. 11 is a cross section of another embodiment of a strain relief component made in accordance with principles of the presently disclosed subject matter.

FIG. 12 is a cross section of another embodiment of a strain relief component made in accordance with principles of the presently disclosed subject matter.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

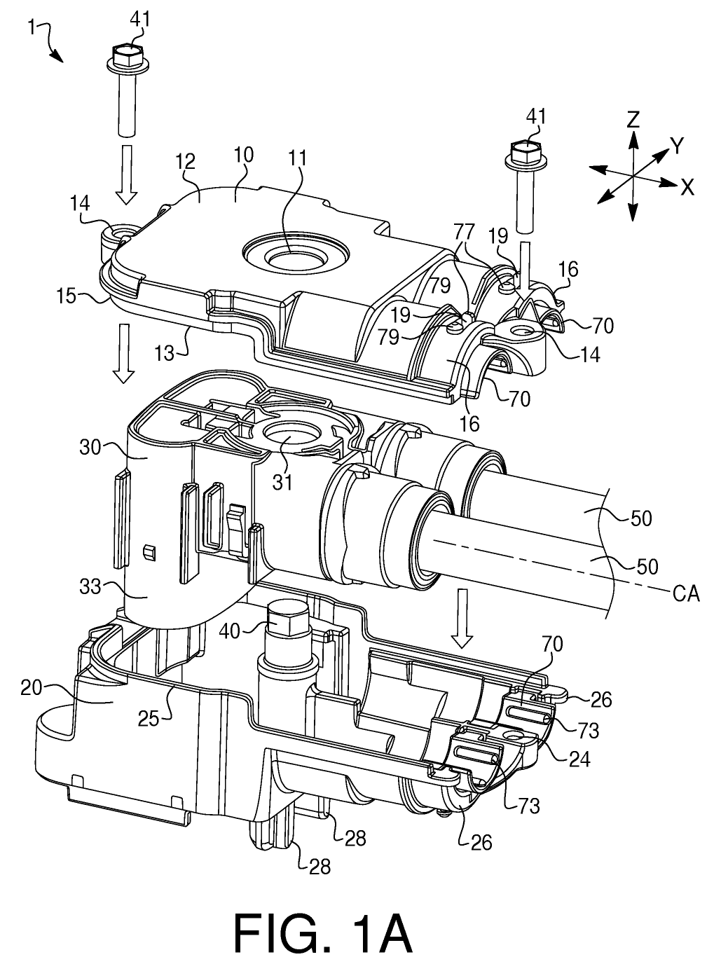

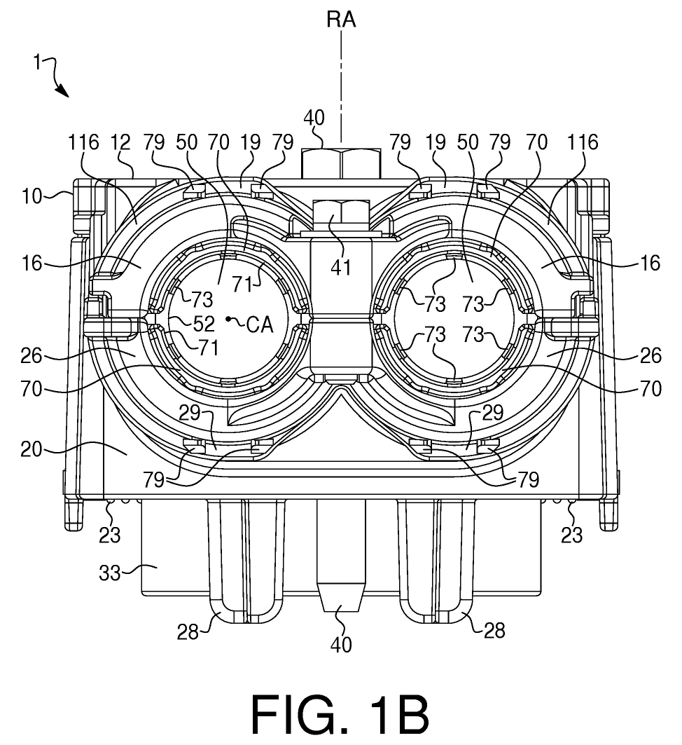

FIG. 1A is a perspective view of a connector 1 made in accordance with principles of the disclosed subject matter. The connector 1 can include a shield shell 10 that is formed as or is connected to a shielding layer enclosing electric wires 50. The shielding layer is omitted from FIG. 1 for clarity and simplicity of the drawing. The shielding layer can be a metal foil or a braided metal wire. The shield shell 10 can cover an electrical terminal 30 and is configured to prevent electromagnetic interference (EMI) or radio frequency interference (RFI) emanating from the terminal 30 (and terminal portions of wires 50) from impacting electronics in a space surrounding the connector 1. The electric terminal 30 is schematically illustrated in phantom in FIG. 1 and can be a male terminal or a female terminal. In this embodiment, the shield shell 10 is a two part shield shell that includes an upper shield 12 and a lower shield 20. The shield shell 10 can be designed to cover a terminal portion of a shielded electrical wire 50 and its associated electrical terminal 30 which transfer electricity from the wire(s) 50 to/from a target or mating component (not shown), such as a motor, an inverter, a battery, or other electronic equipment. The shield shell 10 can be connected to the mating component using a bolt 40. In other embodiments, multiple bolts can be used to secure the shield shell 10 to a mating component. The shield shell could alternatively be mounted by welding, molding, press fit, adhesive or other means. Bolts 41 can connect the upper shield 12 to the lower shield 20 via threaded (or non-threaded) apertures 14 and 24 in the upper shield 12 and lower shield 20, respectively.

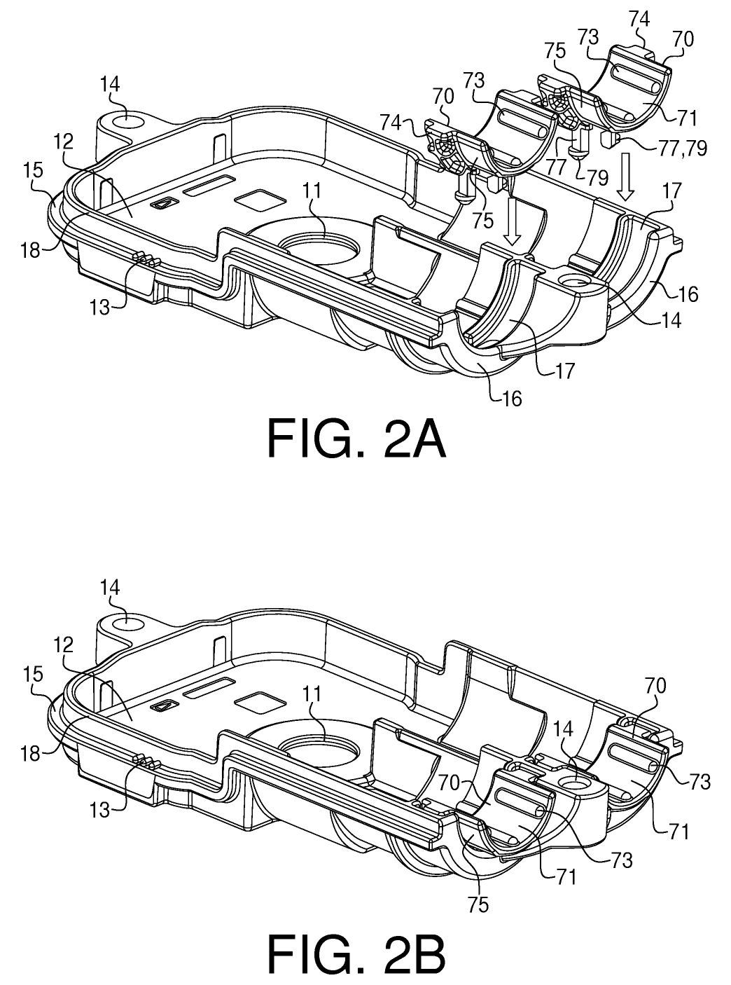

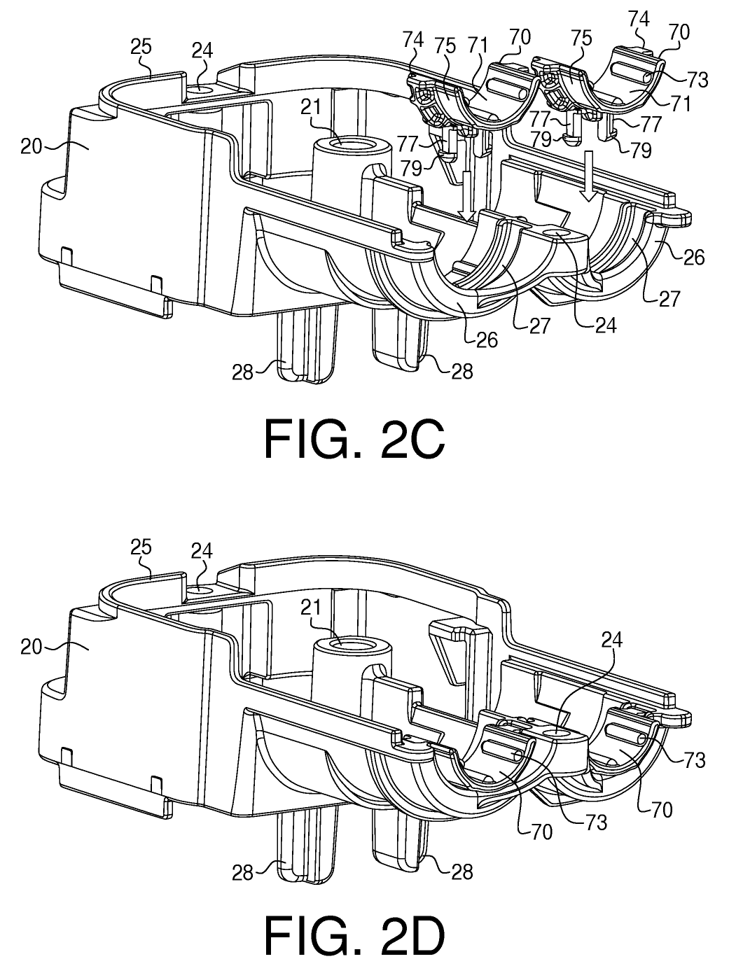

The shield shell 10 can extend in a first direction X, a second direction Y and a third direction Z. The directions X, Y, Z can be orthogonal to each other. The wires 50 can enter the shield shell 10 in the first direction X substantially (exactly or almost) perpendicular to the longitudinal direction or rotational axis RA (FIG. 2) direction of the bolt 40. In this embodiment, the bolt 40 extends through an aperture 11 that runs through the shield shell 10, through an aperture 31 that runs through a housing 33 that contains the terminal 30, and into a mating component located beneath the connector 1. If the bolt 40 is formed as a threaded fastener, the mating component (and/or shield shell 10) can include a threaded portion or aperture for connecting to the bolt 40 and providing the ability to clamp the shield shell 10 to the mating component by force when the bolt is rotated and threads of the bolt 40 are received in threads of the mating component and/or shield shell 10. Alternatively, if the bolt 40 is configured as a rivet type structure or a bolt and nut type structure, a lowermost surface of the mating component (or an uppermost surface of shield shell 10) can include a rivet or nut or weld structure that secures the shaft of the bolt in the apertures 11 and 31. Other structures, including but not limited to clamps, adhesives, and cotter pins can be used to secure the shaft of the bolt 40 within apertures 11, 31 and secure the shield shell 10 to a mating component. Guide posts 28 can be located on a bottom surface of the lower shield shell 20 to guide the shield shell 10 onto a mating structure.

The upper shield shell 12 can include a pair of semicircular channels 16 (or collars, or tubular structures) that are located next to each other and are formed to guide the wires 50 into the shield shell 10. Similarly, the lower shield 20 can include a pair of semicircular channels 26 (or collars or tubular structures) that are located next to each other and are also formed to guide the wires 50 into the shield shell 10. When the upper shield shell 12 is connected to the lower shield shell 20, the semicircular channels 16 combine with semicircular channels 26 to form a shell collar (or collars or tubular structures) 116 through which the wire(s) enter the shield shell 10. In the present embodiment, the collar is configured as two tubular channels through which wires 50 enter the shield shell 10. A strain relief component 70 can be located in each of the tubular channels formed by the assembled semicircular channels 16 and 26. Thus, the connection between each of terminals 30 and the respective one of the wires 50 can be protected against a tensile force acting on the electric wire(s) 50. The strain relief component 70 can also protect against deformation and denigration due to the wires 50 bending in the Y and/or Z axis directions.

Contacts 13 can be provided on or formed in the shield shell 10 at a lowermost surface 15 of the upper shield shell 12 to provide a predictable connection pathway between the lowermost surface 15 of the upper shield shell 12 and the uppermost surface 25 of the lower shield shell 20.

A lowermost surface of the shield shell 10 can be provided with contacts 23 as shown in FIG. 1B. Contacts 23 provide a predictable electrical connection pathway between the lower shield shell 20 and the structure to which the shield shell 10 is mounted. In this manner, a consistent and predictable current pathway can be provided to ground the shield shell 10.

Contacts 13 and 23 can be formed as a single structure at particular locations, or can be formed as multiple structures, such as semispherical protrusions, at each particular location.

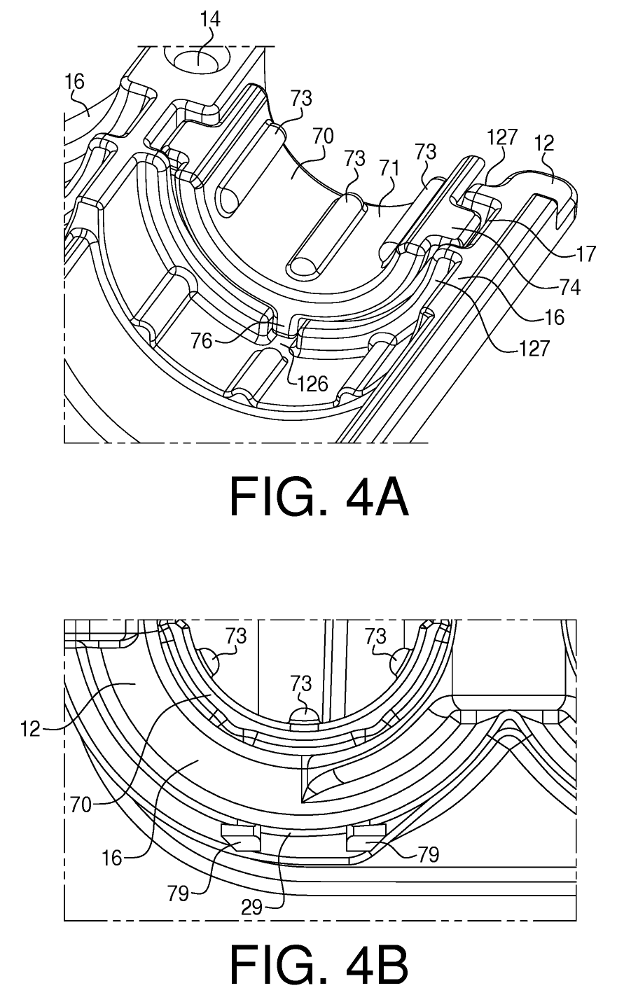

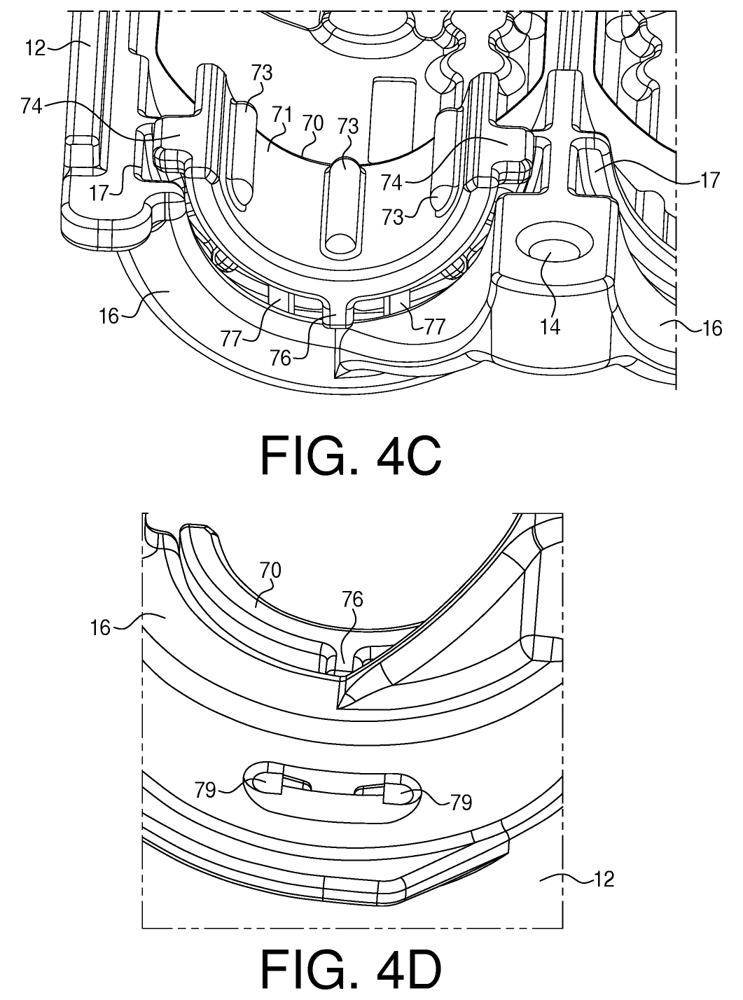

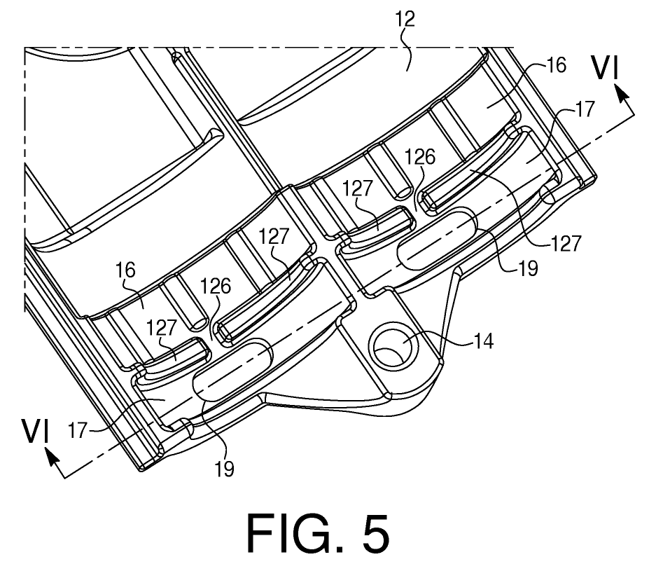

A strain relief component 70 can be located in the semicircular channels 16 and 26. In the present embodiment, the relief component 70 is formed from two rectangular strips that are either pre-formed in an arc or can be bent into an arched (or semicircular) shape. A connector structure 77 can be located on an outer surface 75 of the strain relief component 70. The connector structure 77 can extend through a lock aperture 19 (FIGS. 4D and 5) in the upper shield shell 12 (and lock aperture 29 in lower shield shell 20) to secure the strain relief component 70 to the shield shell 10. The lock apertures 29 of the lower shield shell 20 are obstructed from view and can be the same as or similar to the lock aperture 19 shown in FIGS. 4D and 5. Latching structure 79, such as a protrusion, can be located at a distal end of the connector structure 77 such that when the strain relief component 70 is properly connected to the shield shell 10, the latching structure 79 will act like a hook and overlap a portion of the upper shield shell 12 and lower shield shell 20 to prevent withdrawal of the strain relief component 70 after the connector structure 77 and latching structure 79 are deployed.

FIG. 1B is an end view of the connector of FIG. 1A in which the wires 50 are viewed along a central axis CA of the semicircular channels 16, 26 as the wires 50 extend into the shield shell 10. The central axis CA can be substantially parallel (completely or almost parallel) to the first direction X. In this view, the strain relief component 70 is shown bent (or pre-formed) in a circular manner to extend about substantially (about the entirety or more than half) of the outer perimeter of each wire 50. The strain relief component 70 can include a plurality of ribs 73 that extend from an inner surface 71 of the strain relief component 70 and toward the central axis CA of the semicircular channels 16, 26. The innermost surface of each rib 73 (i.e., the surface closest to central axis CA) is located on (i.e., is tangent to, or forms a part of) an imaginary circle 52. In this embodiment, the imaginary circle 52 is coincident with an outermost diameter of wire 50 for simplicity and clarity of the drawing. The innermost surface of each rib 73 can also be located on an imaginary circle 52 that is slightly smaller than an outer diameter of the respective wire 50 such that each rib 73 elastically or otherwise compresses an outer insulation layer of the wire 50 when secured to the wire 50 within the shield shell 10 to form a strong securing and frictional force to/with the wire 50. The ribs 73 can be equally spaced about the diameter (perimeter) of the wire 50 such that the wire 50 is spaced from the inner surface 71 of the strain relief component 70 between each rib 73. This particular view also highlights the contacts 23 located on the lowermost surface of lower shield 20. Contacts 23 are configured to provide a predictable grounding contact between the shield shell 10 and in particular the lower shield shell 20 with the mating structure (not shown).

The lower shield shell 20 can include a main aperture 21 that is aligned with the aperture 11 of the upper shield shell 12. The bolt 40 can extend through the main aperture 21.

The housing 33 can include a portion that protrudes out of the lower shield shell 20 and into an aperture of the target component or device. The housing 33 can mate with a corresponding connector of the target component of device.

FIGS. 2A-D are perspective views of the exemplary upper shield shell 12 and lower shield shell 20 of the connector 1 in pre-assembled and assembled states with respect to the strain relief component 70. In this embodiment, the strain relief component 70 can include connector structures 77 extending from an outer surface 75 of the strain relief component 70 (outer surface 75 facing away from a central axis CA). A terminal end of each of the connector structures 77 can include a latching structure, such as a protrusion 79. The connector structure 77 and protrusion 79 can be configured to elastically deform when pushed through an aperture, such as lock aperture 19 in the upper shield shell 12, and/or lock aperture 29 in the lower shield shell 20. The strain relief component 70 can include a plurality of ribs 73 that extend from the inner surface 71 of the strain relief component 70 (inner surface 71 facing toward the central axis CA of wire 50 when wire 50 is mounted in shield shell 10). The ribs 73 all extend from the inner surface 71 at a predetermined and specific height or distance. In the depicted embodiment, each of the ribs 73 is formed as an elongate structure that has a longitudinal axis that extends substantially parallel with the central axis CA or, substantially parallel with the central axis CA of the tube formed by semicircular channel 16 and semicircular channel 26 when the upper shield shell 12 is attached to the lower shield shell 20). Each of the ribs 73 also extends a predetermined distance in a radial direction towards the central axis CA. Although the ribs 73 are shown as an elongate structure have a longitudinal axis, the ribs 73 can also be formed as a semispherical or a non-symmetrical structure that extends from the inner surface 71 a predetermined distance in a radial direction towards the central axis CA.

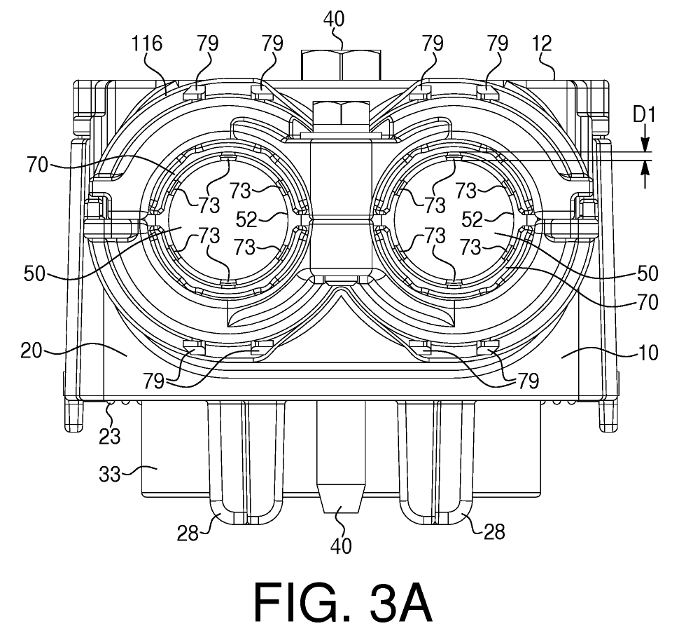

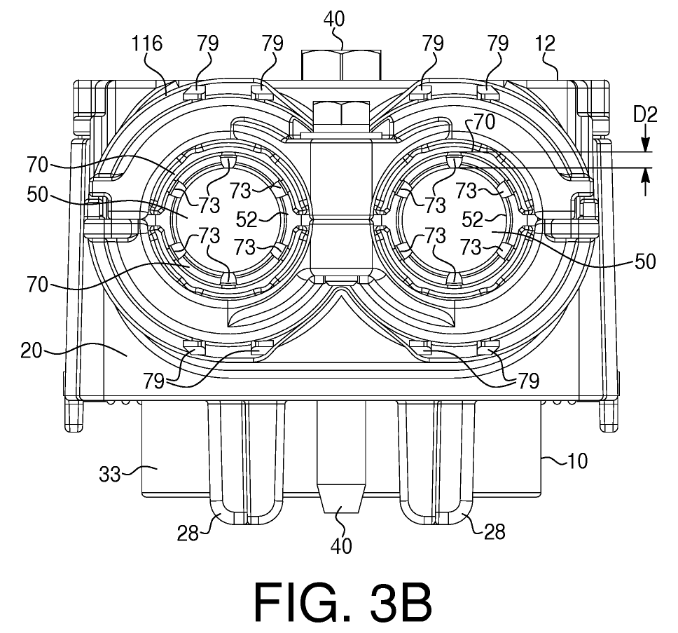

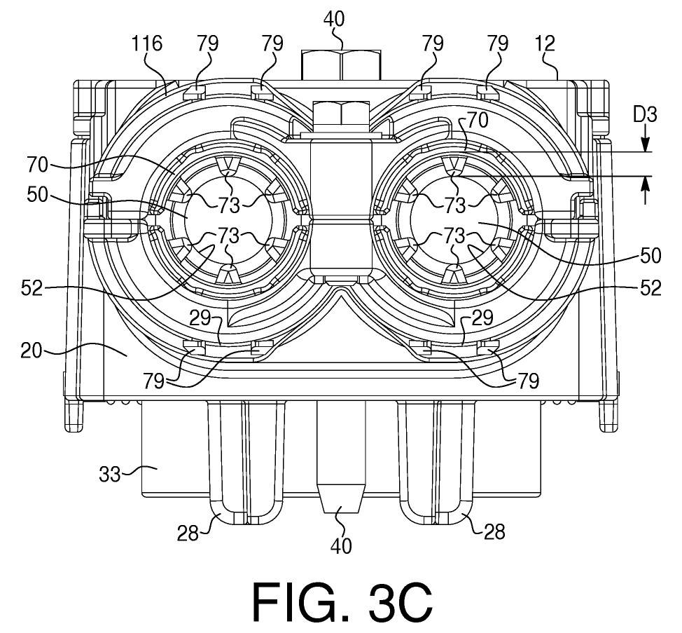

FIGS. 3A-C depict a set of three different strain relief components 70 for use with a same shield shell 10 to form an example of a shield shell kit in accordance with principles of the presently disclosed subject matter. In each of FIGS. 3A-C, the strain relief component 70 is mounted within tubular channels formed by semicircular channels 16 and 26 in the upper shield shell 12 and lower shield shell 20, respectively. The projections 79 can be seen extending from the strain relief component 70 to an area of outside the shield shell 10 to sandwich the shield shell 10 between the barbs 79 and an outer surface 75 of the strain relief component 70. The view of FIGS. 3A-C show the center bolt 40 extending from a top surface of the upper shield shell 12 and exiting the bottom surface of the lower shield shell 20 for connection to a mating structure. Guide posts 28 can be integrally formed in the lower shield shell 20 and extend substantially parallel with the bolt 40 away from the bottom surface of the lower shield shell 20.

The strain relief components 70 shown in each of FIGS. 3A-C are different from each other in that each of the ribs 73 has a different distance (D1, D2, D3), respectively, as measured from the inner surface 71 of each strain relief component 70 to an innermost surface of each rib 73 closest to the cable axis CA. The innermost surfaces of each rib 73 closest to the cable axis CA (when the strain relief component 70 is located in the shell collar 116 of the shield shell 10) are located on the imaginary circle 52. In other words, the innermost surface of each rib 73 in the direction facing inwardly towards the cable axis can form a line, a point, or a tangential surface that intersects with the imaginary circle 52. The imaginary circle 52 is shown to coincide with the outermost surface of the wire 50 for simplicity and clarity of the drawing. However, the outermost surface of the wire 50 can be located between the imaginary circle 52 and the inner surface 71 of the strain relief component 70 such that the ribs 73 compress the outer insulation layer of the wire 50 within the shell collar 116. Thus, each rib 73 provides a contact with the outermost surface of the wire 50 to hold the wire 50 in place within the shell collar 116.

The set of ribs 73 shown in FIG. 3A can have a thickness in a radial direction with a center at the central axis CA measured as distance D1. The thickness being measured from a “root” of the rib 73 (co-planar with the inner surface 71) to an outermost surface or point of the rib 73 located closest to the central axis CA (when the strain relief component 70 is mounted in the shield shell 10). The set of ribs 73 shown in FIG. 3B can have a thickness in a radial direction measured as distance D2, with the distance D1 being different from D2, such that the set of ribs 73 in FIG. 3B can be used on a wire 50 having a smaller diameter than the wire 50 used in FIG. 3A.

Similarly, the strain relief component 70 shown in FIG. 3C can have a set of ribs 73 that are all thicker than the set of ribs 73 shown in the strain relief component 70 of FIGS. 3A and 3B. In particular, the distance D3, which shows the thickness of ribs 73 of FIG. 3C can be greater than the distance D1 or D2 associated with the thickness of ribs 73 of FIGS. 3A and 3B, respectively. In this manner, the strain relief component 70 shown in FIG. 3C can be used on a wire 50 having a diameter that is smaller than the diameter of the wires shown in FIGS. 3A and 3B. When at least two differently sized strain relief components 70 (for example the strain relief component 70 shown in FIG. 3A and 3B) are provided with a shield shell 10, the same shield shell 10 can be used with different diameter wires 50. Thus, the same shield shell 10 can be used with varying sizes of wire 50 by simply selecting a strain relief component 70 that has appropriately sized ribs 73 for the selected wire 50.

The strain relief components 70 shown are two piece structures that can be pre-formed in a semicircular fashion (as viewed from along the central axis CA direction), or can be rectangular strips that are bent into a semicircular shape when fitted or mounted into the shield shell 10. The natural shape of the strain relief component 70 can depend on the material from which it is made and/or if supporting framework is provided within or adjacent the strain relief component 70.

FIGS. 4A and 4B are a perspective view and end view, respectively, of a strain relief component 70 in a correct assembly orientation with respect to the upper shield 12 of the connector 1. The ribs 73 in this embodiment are elongate half cylinder structures running parallel to the central axis CA. Semispherical portions can be formed at either longitudinal end of each of the ribs 73. A transverse key 76 can be provided (attached or integrally molded) into the outer surface 75 of the strain relief component 70. The transverse key 76 can be shaped as an elongate rectangular block that has a longitudinal axis substantially (entirely, or almost (within 10 degrees)) parallel to the central axis CA (or, substantially perpendicular to the longitudinal axis of the strain relief component 70). A transverse receptacle 126 or break in the wall 127 can be provided that mates with the transverse key 76 to prevent the strain relief component 70 from rotating within the semicircular cylinder 16 of the shield shell 10 (i.e., prevent strain relief component 70 from rotating about the central axis CA when the strain relief component 70 is mounted in the shield shell 10).

A radial key 74 can also be provided in (attached or molded into) the outer surface 75 of the strain relief component 70. The radial key 74 can be shaped as an elongate rectangular block that extends along an outer radius of the strain relief component 70 and has a longitudinal axis substantially (entirely, or almost (within 10 degrees)) perpendicular to the central axis CA (or substantially parallel to the longitudinal axis of the strain relief component 70). A radial channel 17 formed by walls 127 can be provided in which the radial key 74 locks into to prevent the strain relief component 70 from moving in or out of the channel 16 in which the wire 50 resides when mounted in the shield shell 10 (i.e., prevent strain relief component 70 from moving along or parallel with the central axis CA).

FIG. 4B shows the projections 79 extending completely through lock aperture 19 in the semicircular channel 16 of the upper shield shell 12. Thus, in this correct connection orientation, the shield shell 10 is located between the projection 79 and the outer surface 75 of the strain relief component 70, and the projection 79 serves as a latching structure to prevent the strain relief component 70 from being easily removed from the channel 16 of the shield shell 10.

FIGS. 4C and 4D depict the strain relief component 70 in an incorrect assembly orientation with respect to the upper shield shell 12. In this case, the connectors 77 have not been pressed fully into lock aperture 19 of the upper shield shell 12 and are therefore exposed from in between the channel 17 of the upper shield shell 12 and the outer surface 75 of the strain relief component 70. In addition, the projections 79 can be seen in FIG. 4D as still remaining flexed towards each other and within the aperture 19 instead of outside of the aperture locking onto the outer surface of the upper shield shell 12. The radial key 74 and transverse key 76 are also shown as not fully seated in their respective channel 17 and receptacle 126. In addition, when the strain relief component 70 is in the incorrect orientation as shown in FIG. 4C/4D, the transverse key 76 is stopped by an uninterrupted rear wall 127 preventing projections 79 from fully locking up when in this orientation, and thus further preventing incorrect installation.

FIG. 5 is a partial upper perspective view of the upper shield shell 12 that shows the channel 17 bounded by walls 127. The transverse receptacle 126 for receiving transverse key 76 is formed by breaks in the walls 127. Semicircular channels 16 formed in the upper shield shell 12 await receipt of the strain relief components 70.

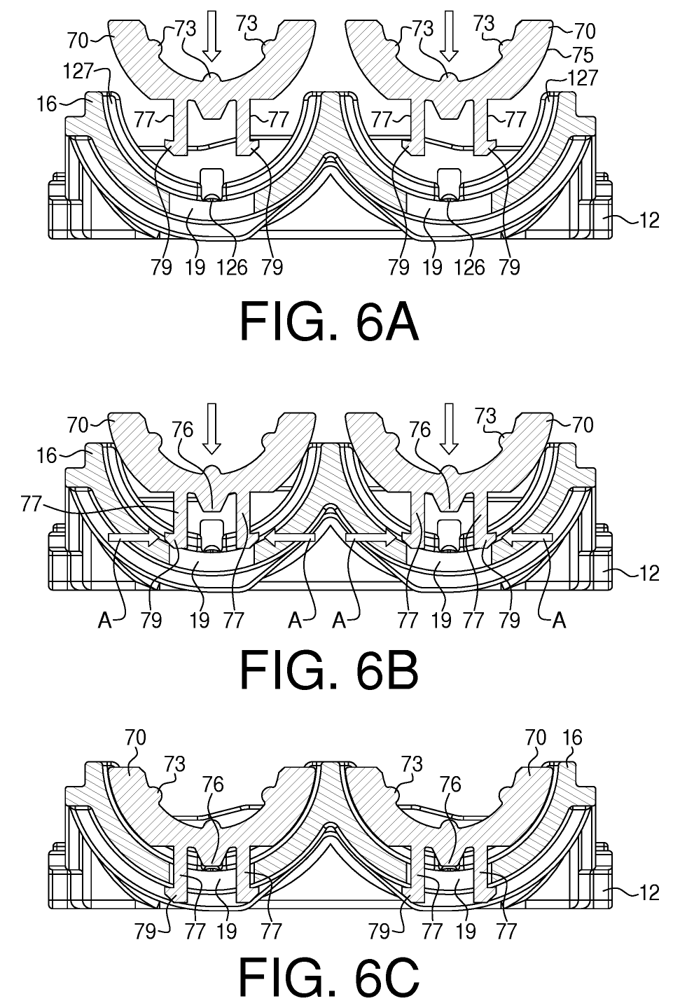

FIGS. 6A-C show iterative steps of an exemplary method for attaching the strain relief component 70 to the upper shield shell 12. In particular, two connector structures 77 can be provided at a lower portion of the outer surface 75 of the strain relief component 70. FIG. 6A shows the strain relief component 70 aligned in an insertion position just prior to attachment to the shield shell 10. FIG. 6B shows strain relief component 70 in a partially inserted state in which the connector structures 77 flex towards each other (in direction of arrows A) within aperture 19 of the upper shield shell 12. FIG. 6C shows the strain relief component 70 in a fully attached state with respect to the upper shield shell 12. In this figure, the projections 79 located at the ends of each connector have flexed back away from each other to engage or lock onto an outer surface of the upper shield shell 12. Thus, the strain relief component 70 can be securely retained on the upper shield shell 12.

Each of the channels 26 in the lower shield shell 20 can also include the lock aperture 29 into which connectors 77 can be inserted in a similar manner as described above with respect to the upper shield shell 12. The strain relief component 70 for the upper shield shell 12 can be configured identical to the strain relief component 70 for the lower shield shell 20, if desired, for efficiency. Of course, the strain relief component 70 for the lower shield shell 20 can also be configured differently than the strain relief component 70 for the upper shield shell 12. For example, the connectors 77 can be located in different locations, configured differently, or entirely removed from either strain relief component 70. The geometrical shape and other characteristics can also be different, provided the ribs 73 contact and appropriately secure the wire 50 within the shield shell 10. Different strain relief components 70 can be provided with the shield shell 10 of this embodiment, where each strain relief component 70 has different sized ribs 73 such that a particular strain relief component 70 with a particular sized rib 73 can be chosen for a particular sized wire 50.

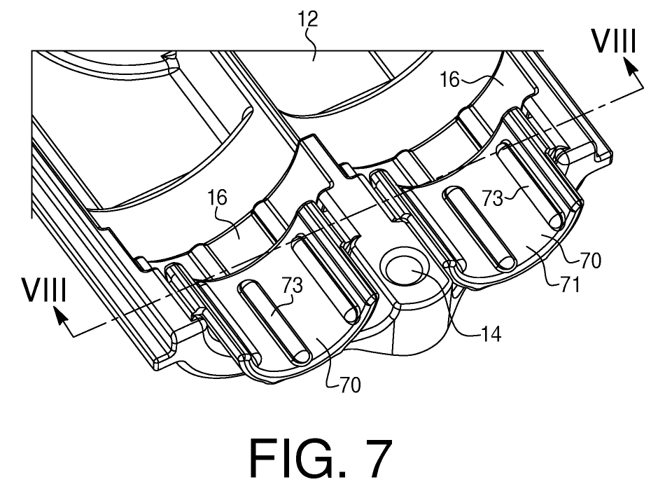

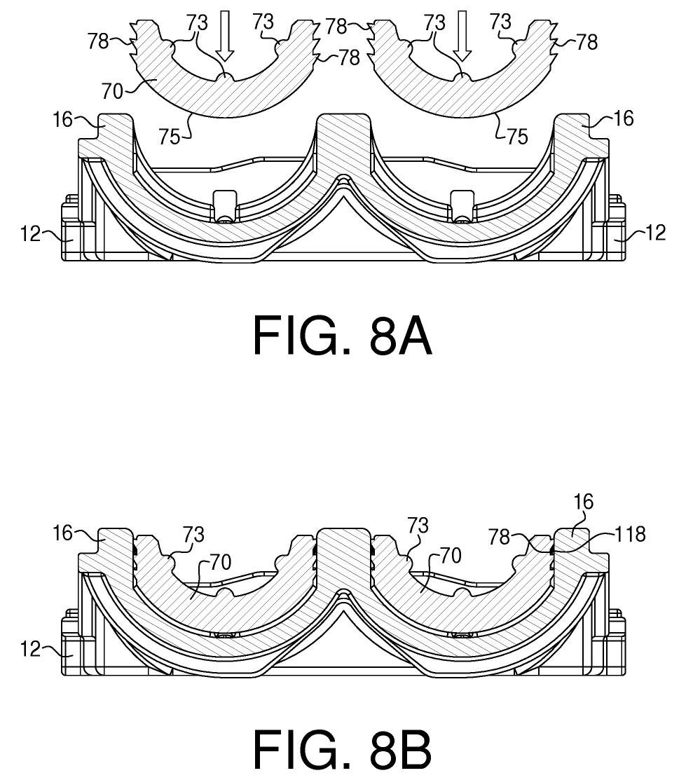

FIGS. 7 and 8A-8B depict another embodiment of a strain relief component 70 and shield shell 10 made in accordance with principles of the disclosed subject matter. In this embodiment, the connectors or connection structure for connecting the strain relief component 70 and shield shell 10 can be an interference structure, such as barbs 78 located at distal ends of the longitudinal axis of each of the strain relief component 70. The inner lip of the upper shield shell 12 can include mating surface 118 that elastically deforms the barbs 78 of the strain relief component 70 as the strain relief component 70 is installed in the insertion direction (shown by the downward arrows in FIG. 8A). The elastic restoring force of the barbs 78 can create an interference fit that prevents movement in a direction opposed to the arrows. Thus, the strain relief component 70 can be secured in the semicircular channels 16 of the upper shield shell 12. Similar or identical connection structure can be provided in the strain relief component 70 for connection to the lower shield shell 20 as well. In addition, ratchets can be provided on an inner wall of the lower shield shell 20 to lock into ratchets 78 of the strain relief component 70.

FIG. 8A is a cross a cross-section take along line VIII-VIII of FIG. 7 with the strain relief component 70 in a pre-assembled position, while FIG. 8B is a cross a cross-section take along line VIII-VIII of FIG. 7 with the strain relief component in an assembled position. Different strain relief components 70 can be provided with the shield shell 10 of this embodiment, where each strain relief component 70 has different sized ribs 73 such that a particular strain relief component 70 with a particular sized rib 73 can be chosen for a particular sized wire 50.

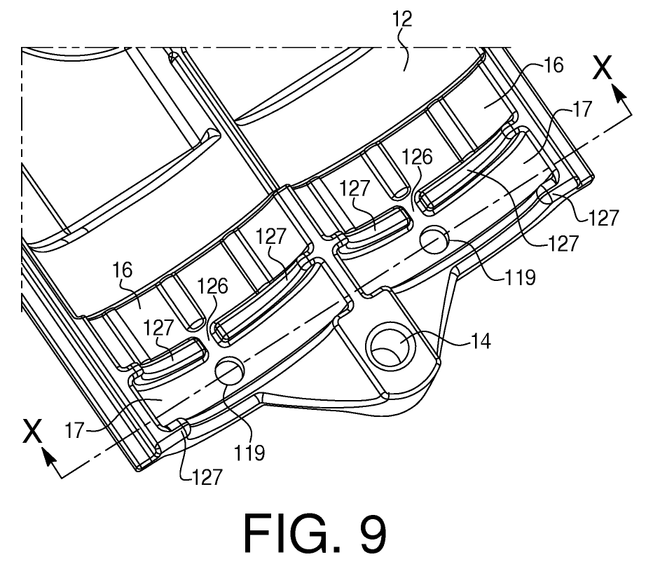

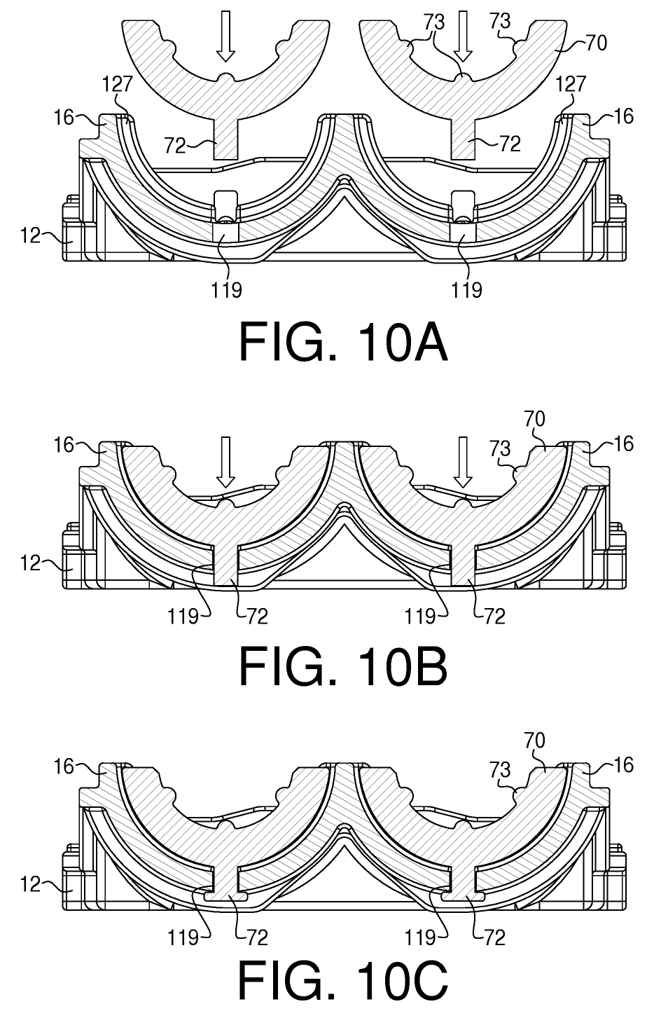

FIGS. 9 and 10A-10C depict another embodiment of a strain relief component 70 and shield shell 10 made in accordance with principles of the disclosed subject matter. In this embodiment, the connectors or connection structure for connecting the strain relief component 70 and shield shell 10 can be a heat stake structure, that includes a heat stake 72 located at a center of each strain relief component 70. The channel 16 of the upper shield shell 12 can include an aperture 119 that allows the stake 72 of the strain relief component 70 to slide into apertures 119 in the insertion direction (shown by the downward arrows in FIGS. 10A and 10B). Once the stake 72 is fully inserted into aperture 119, heat can be applied to a distal end of the heat stake 72 to deform (i.e., melt). Once the distal end cools down, the distal end of the stake 72 will act as a plug or lock to prevent movement of the strain relief component 70 in a direction opposed to the arrows. Thus, the strain relief component 70 can be secured in the semicircular channels 16 of the upper shield shell 12 via the heat stakes 72 as the connection structures. Similar or identical connection structure can be provided in the strain relief component 70 for connection to the lower shield shell 20 as well. In addition, the lower shield shell 20 can be provided with an aperture corresponding to the heat stakes 72 of the strain relief component 70 mounted to the lower shield shell 20 so that the heat stake 72 is deformed and locks the strain relief component 70 to the lower shield shell 20.

FIG. 10A is a cross a cross-section take along line X-X of FIG. 9 with the strain relief component 70 in a pre-assembled position, while FIG. 10B is a cross a cross-section take along line X-X of FIG. 9 with the strain relief component 70 in a partial assembled position, and FIG. 10C is a cross a cross-section take along line X-X of FIG. 9 with the strain relief component 70 in a fully assembled and locked relationship with the upper shield shell 12. Different strain relief components 70 can be provided with the shield shell 10 of this embodiment, where each strain relief component 70 has different sized ribs 73 such that a particular strain relief component 70 with a particular sized rib 73 can be chosen for a particular sized wire 50.

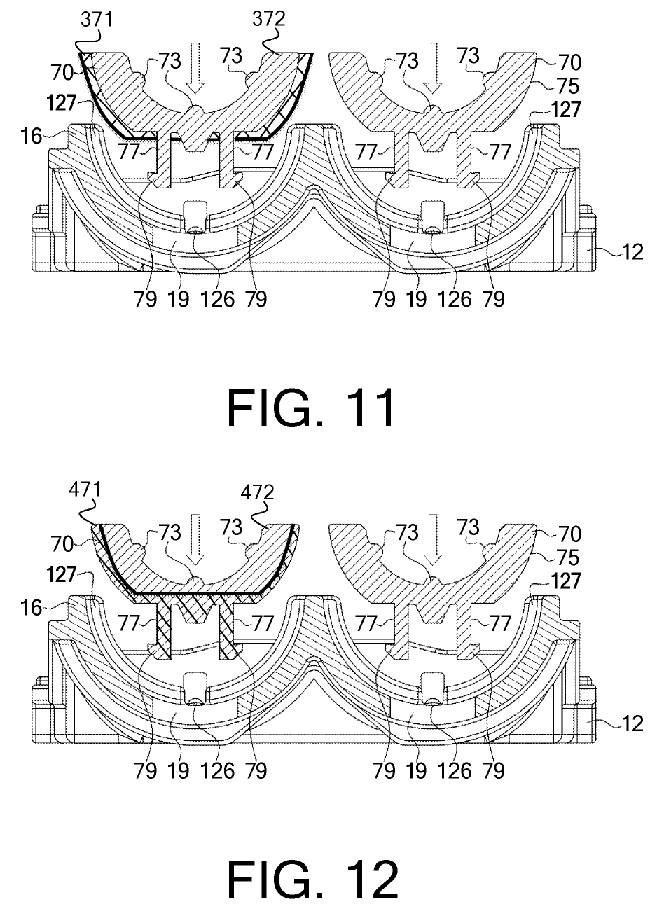

FIG. 11 is a cross section of another embodiment of a strain relief component 70 made in accordance with principles of the presently disclosed subject matter. In this embodiment, the strain relief component 70 can include a hardened lower shell 371 in which a relatively more elastic material insert 372 can be either permanently or selectively fixed to the lower shell 371. The insert 372 can include rib or fit extensions 73 that are sized to fit a particular size wire 50 in the shield shell 10. Inserts 372 having different sized ribs 73 (as compared to a different insert 372) can be provided to allow a user to select an appropriate insert 372 for a particular sized wire 50. Inserts 372 that have larger ribs 73 will be appropriate for a smaller diameter wire 50, while inserts 372 that have smaller ribs 73 will be appropriate for a larger diameter wire 50 (relative to the smaller diameter wire 50). The insert 372 can include connectors 77 that extend through an aperture in the hardened lower shell 371 and are configured to lock into the lock apertures 19, 29 in the upper and lower shield shells 12, 20, respectively. Similarly, the insert 372 can include a transverse key 76 that extends through an aperture in the hardened lower shell 371 and is configured to mate with the receptacle 126 in the upper shield shell 12. A transvers key 76 can also be provided in the insert 372 that is configured for the lower shield shell 20 – this key 76 can mate with a receptacle (not shown) in the lower shield shell 20. In this embodiment, the insert 372 can be made of a rubber material and the lower shell 371 can be made of a less elastomeric material such as a plastic or metal. The insert 372 can be made of other materials, such as plastics, or natural materials, provided they are more elastic than the material constituting the lower shell 371.

FIG. 12 is a cross section of another embodiment of a strain relief component 70 made in accordance with principles of the presently disclosed subject matter. In this embodiment, the strain relief component 70 can include a hardened lower shell 471 in which a relatively more elastic material insert 472 can be either permanently or selectively fixed to the lower shell 471. The insert 472 can include rib or fit extensions 73 that are sized to fit a particular size wire 50 in the shield shell 10. Inserts 472 having different sized ribs 73 (as compared to a different insert 472) can be provided to allow a user to select an appropriate insert 472 for a particular sized wire 50. Inserts 472 that have larger ribs 73 will be appropriate for a smaller diameter wire 50, while inserts 472 that have smaller ribs 73 will be appropriate for a larger diameter wire 50 (relative to the smaller diameter wire 50). The lower shell 471 can include connectors 77 that extend from a lower surface thereof and are configured to lock into the lock apertures 19, 29 in the upper and lower shield shells 12, 20, respectively. Similarly, the lower shell 471 can include a transverse key 76 that extends from a lower surface of the lower shell 471 and is configured to mate with the receptacle 126 in the upper shield shell 12. A transverse key 76 can also be provided in the lower shell 471 that is configured for use with the lower shield shell 20 – this key 76 can mate with a receptacle (not shown) in the lower shield shell 20. In this embodiment, the insert 472 can be made of a rubber material and the lower shell 471 can be made of a less elastomeric material such as a plastic or metal. The insert 472 can be made of other materials, such as plastics, or natural materials, provided they are more elastic than the material constituting the lower shell 471.

In the embodiments noted above, the elastomer inserts 372, 472 allows more variation in stiffness than rigid plastic so the clamping force can be tuned by changing elastomer properties. Elastomer inserts 372, 472 can also be more compliant than a solid plastic or metal part (i.e., more compliant than shell 371, 471) meaning that the elastomer inserts 372, 472 can be more tolerant of wire size variation and potentially geometry, and could cover multiple wire sizes if similar enough (for example, 25mm² and 35mm² or 50mm² ISO and 50mm² JASO standard wires 50) and even flat cables or other types of geometrically shaped wires.

In the above described embodiments, the elastomer inserts 372, 472 can be molded to the plastic shells 371, 471 respectively, in order to fit any size/shape wire 50. The plastic shell 371, 472 can be a common part in which various sized and shaped inserts 372, 472 can be molded, inserted, adhered or otherwise attached.

Most elastomers will be more resistant to stress relaxation at temperature than rigid plastic engaging the wire, meaning the joint will maintain more compression after temperature exposure.

While certain embodiments of the invention are described above, it should be understood that the invention can be embodied and configured in many different ways without departing from the spirit and scope of the invention.

Various embodiments are disclosed above. It is contemplated that any particular feature of a disclosed embodiment could also be incorporated into any or all of the other disclosed embodiments. In other words, the features of all embodiments should be considered interchangeable with (or added to) feature(s) of other embodiments.

It is contemplated that the shield shell 10 can be die-cast aluminum and the mating component also be made of die-cast aluminum. The material that makes up the shield shell 10 or mating component could alternatively be a different metal material such as steel or composites of steel, aluminum or other metals, ceramic materials, or plastics embedded with metal or ceramic shielding material such as metal fibers, meshes, nets or other known or future known EMC shielding materials.

The strain relief components 70 can be made from a material that has more elasticity than the shield shell 10. For example, the strain relief components 70 can be made from a plastic, or a rubber. While the ribs 73 are shown as elongate semi-cylindrical structures, they can be formed in many various ways and still be within the spirit and scope of the presently disclosed subject matter. For example, the ribs 73 can be formed has hemispherical structures, as rectangular block like structures, gear teeth type shaped structures, or other various shapes. The ribs 73 can be integrally formed with and of a homogenous material with the body and/or surface 71 of strain relief component 70. The closest inner radial surface (or line, or point) of each rib 73 should coincide or intersect the imaginary circle 52 which is typically smaller than an outer surface of each wire 52. However, when wire 50 is not circular in cross-section, the closest inner radial surface of each rib 73 can be located on a shape that corresponds to a shape that is complementary to and a size that slightly smaller than the cross-section of the wire 50.

The number of strain relief components 70 with different sized ribs 73 in a kit can correspond to the number of wires 50 contemplated for use with the shield shell 10 of the kit. One of the strain relief components 70 in a kit that includes multiple strain relief components 70 can be provided with a smooth inner surface 71 that does not include ribs 73 and is intended for use with a largest diameter wire 50 for use with shield shell 10. Other strain relief components 70 of the given kit can include different sized ribs 73. The number of ribs 73 located on each strain relief component 70 can be determined based on a particular application. In the depicted embodiments, each rib 73 is identical to other ribs on a given strain relief component 70. However, it is contemplated that ribs 73 can be differently shaped on a same strain relief components 70 provided they are shaped to adequately secure a wire 50 within the respective shield shell 10. Further, strain relief components 70 that have differing thicknesses in a radial direction (i.e., from inner surface 71 to outer surface 75) can be used with or without ribs 73. The different thicknesses (from inner surface 71 to outer surface 75) can also be used for providing strain relief components 70 for different sized wires. In this case, the location of the innermost surface of ribs 73 can be changed by the thickness from inner surface 71 to outer surface 75 instead of by thickness of rib 73 itself.

While we have described the connector 1 for use in a passenger automobile type vehicle’s wiring harness, the connector 1 can also be applied to other vehicle wiring harnesses, including pickup trucks, SUVS, vans, tractor trailers, motorcycles, aircraft, trains, boats, and even spacecraft. In addition, any high voltage wire harness application could benefit from the presently disclosed subject matter including wiring for housing and commercial building and machine applications.

The thickness in the radial axis direction of each rib 73 can be the same or differ from each other, and can be adjusted to optimize contact force to the wire 50. The shield shell 10 can be made as a unitary cast structure or can be multiple parts. Contacts 13 can be located between each of the multiple parts of the shield shell 10, or can be located only on the lowermost surface of the shield shell 10 (and/or mating component). The number and position of contacts 13 can be determined based on each specific application, and on where and how force and grounding distributions are desired for a particular connector.

The mating component can be a device such as a motor, inverter, alternator, battery, etc. to which shield shell 10 is attached. Alternatively, the mating component can be a part of a multiple part shield shell 10. Further, the mating component can be a separate structure that is configured to then attach the connector 1 to a device or bracket or other vehicle component.

While the wires 50 are shown as a pair of wires entering the shield shell 10 along a longitudinal axis direction L, it is contemplated that the disclosed subject matter could be used with more than two wires, with a single wire, and with any or all wires extending into the shield shell 10 at various directions other than (and including) the longitudinal axis direction L.

The disclosed subject matter can include a method for using a kit that includes a shield 10 and multiple strain relief components 70. The method can include selecting a shield wire strain relief component 70 from a plurality of strain relief components 70 depending on a size of wire 50 desired for use with a shield shell 10.

While the subject matter has been described in detail with reference to exemplary embodiments thereof, it will be apparent to one skilled in the art that various changes can be made, and equivalents employed, without departing from the scope of the invention as set forth in the claims.

What is claimed is:

1. An electrical connection kit for a wire harness cable and electrical terminal, the electrical connection kit comprising:
a shield shell configured to cover at least a portion of the electrical terminal and having a shell collar configured to at least partially surround the wire harness cable when the wire harness cable extends along a cable axis into the shield shell;
a first strain relief component having an inner surface configured to face the cable axis and an outer surface configured to mate with the shell collar, the first strain relief component including a plurality of first ribs extending from the inner surface towards the cable axis when the first strain relief component is located in the shell collar, and each of the first ribs extending in a longitudinal direction that is parallel with the cable axis, wherein an innermost surface closest to the cable axis of each of the first ribs is located on an imaginary circle having a diameter of a first value when the first strain relief component is located in the shell collar; and
a second strain relief component having an inner surface configured to face the cable axis and an outer surface configured to mate with the shell collar, the second strain relief component including a plurality of second ribs extending from the inner surface of the second strain relief component towards the cable axis when the second strain relief component is located in the shell collar, and each of the second ribs extending in a longitudinal direction that is parallel with the cable axis, wherein an innermost surface closest to the cable axis of each of the second ribs is located on an imaginary circle having a diameter of a second value when the second strain relief component is located in the shell collar, and the first value is different from the second value, such that the first strain relief component is configured for use with a wire harness cable having a first diameter, and the second strain relief component is configured for use with a wire harness cable having a second diameter different than the first diameter.

2. The electrical connection kit for a wire harness cable and electrical terminal according to claim 1, further comprising:
a third strain relief component having an inner surface configured to face the cable axis and an outer surface configured to mate with the shell collar, the third strain relief component including a plurality of third ribs extending from the inner surface towards the cable axis when the third strain relief component is located in the shell collar, and each of the third ribs extending in a longitudinal direction that is parallel with the cable axis, wherein an innermost surface of each of the third ribs is located on an imaginary circle having a diameter of a third value when the third strain relief component is located in the shell collar, and the first value and second value are different from the third value, such that the third strain relief component is configured for use with a wire harness cable having a third diameter different than each of the first diameter and the second diameter.

3. The electrical connection kit for a wire harness cable and electrical terminal according to claim 1, wherein the first strain relief component includes a connector structure extending from the outer surface of the first strain relief component.

4. The electrical connection kit for a wire harness cable and electrical terminal according to claim 3, wherein the connector structure includes a first latch with a first protrusion at a terminal end of the first latch, and a second latch with a second protrusion at a terminal end of the second latch, wherein the first protrusion extends away from the second protrusion, and the second protrusion extends away from the first protrusion.

5. The electrical connection kit for a wire harness cable and electrical terminal according to claim 4, wherein the shell collar of the shield shell includes a lock aperture, and the connector structure extends entirely through the lock aperture from the outer surface of the first strain relief component to a location on an outside surface of the shield shell when the first strain relief component is mounted on the shield shell such that the first protrusion and second protrusion are located on opposite sides of the lock aperture and the shield shell is located between the first protrusion and the outer surface of the first strain relief component and the shield shell is also located between the second protrusion and the outer surface of the first strain relief component.

6. The electrical connection kit for a wire harness cable and electrical terminal according to claim 1, wherein the first strain relief component includes a first half including a plurality of the first ribs and a second half including a plurality of the first ribs, wherein the first half and second half are completely separate structures mountable within the shell collar.

7. The electrical connection kit for a wire harness cable and electrical terminal according to claim 6, wherein the shield shell includes an upper shield shell and a lower shield shell, the upper shield shell and lower shield shell being completely separate structures connectable to each other to form the shell collar.

8. The electrical connection kit for a wire harness cable and electrical terminal according to claim 1, wherein the shield shell includes an upper shield shell and a lower shield shell, the upper shield shell and lower shield shell being completely separate structures connectable to each other, and the upper shield shell includes a semicircular collar defined therein that mates with a semicircular collar defined in the lower shield shell to form the shell collar when the upper shield shell and lower shield shell are connected to each other, and the semicircular collar defined in the upper shield shell has a radius extending from the cable axis, and the semicircular collar defined in the lower shield shell has a radius extending from the cable axis.

9. The electrical connection kit for a wire harness cable and electrical terminal according to claim 1, wherein the first strain relief component includes a connector structure extending from the outer surface of the first strain relief component, and a transverse key structure and radial key structure extending from the outer surface of the first strain relief component.

10. The electrical connection kit for a wire harness cable and electrical terminal according to claim 1, wherein the first strain relief component includes a connector structure extending from the outer surface of the first strain relief component, and the connector structure is configured as at least one of a barb and a heat stake.

11. The electrical connection kit for a wire harness cable and electrical terminal according to claim 1, wherein the shield shell is made from a metal material and the first strain relief component and second strain relief component are made from at least one of a plastic and a rubber material.

12. An electrical connection kit for a cable and electrical terminal, the electrical connection kit comprising:
a shield shell including an upper shield shell, a lower shield shell, and connector structure configured to connect the upper shield shell to the lower shield shell, the upper shield shell and lower shield shell forming at least one tubular channel configured to receive the cable when the upper shield shell is connected to the lower shield shell, and the tubular channel having a cable axis along which the cable extends into the shield shell when the cable is mounted in the tubular channel of the shield shell, the shield shell made from an electromagnetic compatibility material;
a first strain relief component having an inner surface configured to face the cable axis and an outer surface configured to mount to an inner circumferential surface of the tubular channel of the shield shell, the first strain relief component including a plurality of first ribs extending from the inner surface towards the cable axis when the first strain relief component is mounted to the tubular channel of the shield shell, wherein an innermost surface closest to the cable axis of each of the first ribs is located on an imaginary circle having a diameter of a first value when the first strain relief component is mounted to the tubular channel of the shield shell, the first strain relief component made from a material having higher elasticity than the electromagnetic compatibility material; and
a second strain relief component having an inner surface configured to face the cable axis and an outer surface configured to mount to the inner circumferential surface of the tubular channel of the shield shell, the second strain relief component including a plurality of second ribs extending from the inner surface of the second strain relief component towards the cable axis when the second strain relief component is mounted to the tubular channel of the shield shell, wherein an innermost surface closest to the cable axis of each of the second ribs is located on an imaginary circle having a diameter of a second value when the second strain relief component is mounted to the tubular channel of the shield shell, and the first value is different from the second value, such that the first strain relief component is configured for use with a cable having a first diameter, and the second strain relief component is configured for use with a cable having a second diameter different than the first diameter, the second strain relief component made from a material having higher elasticity than the electromagnetic compatibility material.

13. The electrical connection kit for a wire harness cable and electrical terminal according to claim 12, further comprising:
a third strain relief component having an inner surface configured to face the cable axis and an outer surface configured to mount to the inner circumferential surface of the tubular channel of the shield shell, the third strain relief component including a plurality of third ribs extending from the inner surface towards the cable axis when the third strain relief component is mounted to the inner circumferential surface of the tubular channel of the shield shell, wherein an innermost surface of each of the third ribs is located on an imaginary circle having a diameter of a third value when the third strain relief component is mounted to the inner circumferential surface of the tubular channel of the shield shell, and the first value and second value are different from the third value, such that the third strain relief component is configured for use with a cable having a third diameter different than each of the first diameter and the second diameter, the third strain relief component made from a material having higher elasticity than the electromagnetic compatibility material.

14. The electrical connection kit for a wire harness cable and electrical terminal according to claim 12, wherein the shield shell is made from a metal material and the first strain relief component and second strain relief component are made from at least one of a plastic and a rubber material.

15. The electrical connection kit for a wire harness cable and electrical terminal according to claim 12, wherein the first strain relief component includes a connector structure extending from the outer surface of the first strain relief component.

16. The electrical connection kit for a wire harness cable and electrical terminal according to claim 15, wherein the connector structure includes a first latch with a first projection at a terminal end of the first latch, and a second latch with second projection at a terminal end of the second latch, wherein the first projection extends away from the second projection, and the second projection extends away from the first projection, wherein
the tubular channel of the shield shell includes an lock aperture, and the connector structure extends entirely through the lock aperture from the outer surface of the first strain relief component to a location on an outside surface of the shield shell when the first strain relief component is mounted on the shield shell such that the first projection and second projection are located on opposite sides of the lock aperture and the shield shell is located between the first projection and the outer surface of the first strain relief component and the shield shell is also located between the second projection and the outer surface of the first strain relief component.

17. The electrical connection kit for a wire harness cable and electrical terminal according to claim 12, wherein the first strain relief component includes a connector structure extending from the outer surface of the first strain relief component, and a transverse key structure and radial key structure extending from the outer surface of the first strain relief component.

18. A method for connecting a shield shell to a cable and electrical terminal, comprising:
providing a shield shell including an upper shield shell, a lower shield shell, and a connector structure configured to connect the upper shield shell to the lower shield shell, the shield shell made from an electromagnetic compatibility material;
providing a first strain relief component having an inner surface including a plurality of first ribs extending from the inner surface a first distance, the first strain relief component made from a material having higher elasticity than the electromagnetic compatibility material;
providing a second strain relief component having an inner surface including a plurality of second ribs extending from the inner surface a second distance different from the first distance, the second strain relief component made from a material having higher elasticity than the electromagnetic compatibility material;
selecting a cable having an outer diameter;
selecting one of the first strain relief component and second strain relief component depending on a value of the outer diameter of the cable;
mounting the selected one of the first strain relief component and second strain relief component to the shield shell;
placing the electrical terminal and cable adjacent at least one of the upper shield shell and lower shield shell; and
connecting the upper shield to the lower shield shell after the selected one of the first strain relief component and second strain relief component is mounted to the shield shell such that an innermost surface of the plurality of ribs is coincident with the outer diameter of the cable and the cable is firmly held by the selected one of the first strain relief component and second strain relief component.

19. The method of claim 18, further comprising:
placing a connector structure extending from an outer surface of the selected one of the first strain relief component and second strain relief component into an aperture in the shield shell to lock the selected one of the first strain relief component and second strain relief component to the shield shell, the connector structure including a projection at a distal end, and the shield shell being located between the projection and the outer surface along a radial line from a center of the cable when the cable is firmly held by the selected one of the first strain relief component and second strain relief component.

20. The method of claim 18, further comprising:
placing a connector structure extending from an outer surface of the selected one of the first strain relief component and second strain relief component into an aperture in the shield shell to lock the selected one of the first strain relief component and second strain relief component to the shield shell;
placing a transverse key structure extending from the outer surface of the selected one of the first strain relief component and second strain relief component into a transverse key structure of the shield shell to lock the selected one of the first strain relief component and second strain relief component to the shield shell in a transverse direction; and
placing a radial key structure extending from the outer surface of the selected one of the first strain relief component and second strain relief component into a radial key structure of the shield shell to lock the selected one of the first strain relief component and second strain relief component to the shield shell in a radial direction that is perpendicular to the transverse direction.
